(19) United States
(12) Patent Application Publication
(10) Pub. No.: US 2025/0310524 A1
(43) Pub. Date: Oct. 2, 2025

(54) METHOD, AND ELECTRONIC DEVICE FOR PROCESSING A VIDEO

(71) Applicant: SAMSUNG ELECTRONICS CO., LTD., Suwon-si (KR)

(72) Inventors: Pritha GANGULY, Bengaluru (IN); Aviral Agrawal, Ghaziabad (IN); Anubhav Singh, Bengaluru (IN); Raj Narayana Gadde, Bengaluru (IN); Yinji Piao, Suwon-si (KR); Minwoo Park, Suwon-si (KR); Kwangpyo Choi, Suwon-si (KR)

(73) Assignee: SAMSUNG ELECTRONICS CO., LTD., Suwon-si (KR)

(21) Appl. No.: 19/237,865

(22) Filed: Jun. 13, 2025

Related U.S. Application Data
(63) Continuation of application No. PCT/KR2023/019624, filed on Nov. 30, 2023.

(30) Foreign Application Priority Data
Dec. 13, 2022 (IN) 202241072050
Aug. 31, 2023 (IN) 202241072050

(51) Int. Cl. H04N 19/117; H04N 19/14; H04N 19/172; H04N 19/82

(52) U.S. Cl. CPC H04N 19/117; H04N 19/14; H04N 19/172; H04N 19/82

(57) ABSTRACT

A method of processing a video, including: obtaining a plurality of reconstructed frames associated with a compressed video; determining a priority level of each reconstructed frame from among the plurality of reconstructed frames; extracting a set of patches from the plurality of reconstructed frames; and obtaining an artificial intelligence (AI)-based in-loop filter trained based on at least one of the set of patches and the priority level.

### CROSS-REFERENCE TO RELATED APPLICATIONS

This application is a continuation of International Application No. PCT/KR2023/019624, filed on Nov. 30, 2023, in the Korean Intellectual Property Receiving Office, which is based on and claims priority to Indian Provisional Patent Application No. 202241072050 filed on Dec. 13, 2022, and Indian Patent Application number 202241072050 filed on Aug. 31, 2023, in the Indian Patent Office, the disclosures of which are incorporated by reference herein in their entireties.

### BACKGROUND

### 1. Field

The present disclosure relates to image processing, and more particularly to an electronic device and a method for removing one or more artifacts from a video during video compression.

### 2. Description of Related Art

Video compression, also known as video coding, may refer to a process that reduces the size of digital video files while maintaining an acceptable level of visual quality. One goal of video compression may be to decrease an amount of data used to store or transmit a video, making it more efficient for storage, streaming, and transmission over various networks. With the advancements in technology, Artificial Intelligence (AI)-based coding tools may be used in a compression pipeline associated with the video compression. For an AI-based coding tool to be a part of the compression pipeline, the AI-based coding tool should improve quality of an image or video while reducing the transmission cost. Further, the AI-based coding tool may be light-weight in terms of its memory and computation requirements. Therefore, low-complexity and small AI models with few parameters may be used to make the AI-based coding tools device-friendly.

In general, training data may play an important role in AI-based models for enabling the AI-based models to learn correct features. The significance of the training data may become more pronounced while training low-complexity and light-weight AI-based models, as these AI-based models may lack multiple parameters to learn all intricacies that exist within the training data. In other words, the low-complexity and light-weight AI-based models may tend to under-fit and have poor generalization capabilities. In video codecs, each frame has its distinct importance which translates to the final compression gain. For example, frames that may occur early in Group of Pictures (GOP) hierarchy (e.g., sequence of pictures) may have higher importance as they may be used as reference for later frames. Also, while encoding a video in the compression pipeline, each frame may have its own importance which may translate to a final Bjontegaard Delta (BD)-rate gain. Therefore, it may be important to focus on the quality enhancement of important frames rather than the unimportant frames, for an overall performance boost.

Some solutions may use AI-based models in the compression pipeline. However, in these solutions, the AI-based models may either be used to replace certain compression blocks, or may be used in conjunction with a compression block. For example, AI-based in-loop filters may be used along with other loop filters to detect and correct a certain type of artifacts. The AI-based in-loop filters, also known as AI-based loop filters or AI-based deblocking filters, are a cutting-edge enhancement in video compression technology that leverages AI techniques to improve video quality during the decoding process. For training such AI-based models, training patches may be collected based on the input which an AI-based in-loop filter receives. For example, if the AI-based in-loop filter is placed after other filters, the output of the other filters may serve as input to the AI-based models. However, in the GOP, some frames may have higher priority than other frames. Thus, any quality loss which may be present in these high priority frames may propagate to frames which refer to the high priority frames. In general, the frames with lower priority may be quantized with a relatively higher Quantization Parameter (QP) value and its blocks may often be skipped by an encoding pipeline. Therefore, extracting the training patches from such frames may not add any value to the training data. Further, this additional data (e.g., training patches) may disorganize and deviate the focus of the low-complexity and small AI models from learning the correct features. Further, in other solutions, a specific AI-based model may be trained for different frame-types, such as based on position of each frame in the GOP. However, such specific models may lack generalization capability. For training different AI-models, different subsets of training data may be used for training these AI-models which may be time and memory intensive.

Accordingly, there is a need for an improved technique and method that may overcome the above-identified problems and limitations associated with the conventional techniques and method for removing artifacts from the videos.

### SUMMARY

In accordance with an aspect of the disclosure, a method of processing a video includes: obtaining a plurality of reconstructed frames associated with a compressed video; determining a priority level of each reconstructed frame from among the plurality of reconstructed frames; extracting a set of patches from the plurality of reconstructed frames; and obtaining an artificial intelligence (AI)-based in-loop filter trained based on at least one of the set of patches and the priority level.

The method may further include: receiving one or more characteristics associated with the AI-based in-loop filter, wherein the one or more characteristics comprise at least one of a size, a complexity, and an application corresponding to the AI-based in-loop filter; and generating a patch extraction criteria for extracting the set of patches based on the one or more characteristics.

The obtaining of the AI-based in-loop filter may include: determining a priority of each patch from among the set of patches based on the priority level; and obtaining the AI-based in-loop filter based on the set of patches, the compressed video, and the priority of each patch.

The determining the priority level of each reconstructed frame may include: determining a first parameter set comprising first parameters associated with the plurality of reconstructed frames without using one or more in-loop filters; determining a second parameter set comprising second parameters associated with the plurality of reconstructed frames using the one or more in-loop filters; calculating differences between each first parameter included in the first parameter set and each second parameter included in the second parameter set; and determining the priority level of each reconstructed frame based on the differences.

The determining of the priority level of each reconstructed frame may include: obtaining a temporal identifier (ID) for each reconstructed, wherein the temporal ID corresponds to a sequence comprising each reconstructed frame; and determining the priority level each reconstructed frame based on the temporal ID.

The plurality of reconstructed frames may include high priority level frames and low priority level frames, wherein the high priority level frames have a higher priority level than the low priority level frames, and the obtaining of the AI-based in-loop filter may include: generating a loss value using a weighted loss-function, wherein the weighted loss-function is modulated to be influenced more by one or more patches extracted from the high priority level frames than one or more patches extracted from the low priority level frames; and training the AI-based in-loop filter based on the loss value.

The method may further include: filtering the plurality of reconstructed frames using the AI-based in-loop filter.

The extracting the set of patches may include: extracting a first set of patches from a first set of reconstructed frames from among the plurality of reconstructed frames, wherein each frame included in the first set of reconstructed frames has a first priority level; and extracting a second set of patches from a second set of reconstructed frames from among the plurality of reconstructed frames, wherein each frame included in the second set of reconstructed frames has a second priority level, and a number of patches included in the first set of reconstructed frames may be greater than a number of patches included in the second set of reconstructed frames.

In accordance with an aspect of the disclosure, an electronic device for processing a video includes: at least one processor; and a memory configured to store at least one instruction which, when executed by the at least one processor, causes the electronic device to: obtain a plurality of reconstructed frames associated with a compressed video; determine a priority level of each reconstructed frame from among the plurality of reconstructed frames; extract a set of patches from the plurality of reconstructed frames; and obtain an artificial intelligence (AI)-based in-loop filter that is trained based on at least one of the set of patches and the priority level.

The at least one instruction, when executed by the at least one processor, may further cause the electronic device to: receive one or more characteristics associated with the AI-based in-loop filter, wherein the one or more characteristics comprise at least one of a size, complexity, and an application corresponding to the AI-based in-loop filter; and generate a patch extraction criteria for extracting the set of patches based on the one or more characteristics.

The at least one instruction, when executed by the at least one processor, may further cause the electronic device to: determine a priority of each patch from among the set of patches based on the priority level; and obtain the AI-based in-loop filter based on the set of patches, the compressed video, and the priority of each patch.

The at least one instruction, when executed by the at least one processor, may further cause the electronic device to: determine a first parameter set comprising first parameters associated with the plurality of reconstructed frames without one or more in-loop filters; determine a second parameter set comprising second parameters associated with the plurality of reconstructed frames using the one or more in-loop filters; calculate differences between each first parameter included in the first parameter set and each second parameter included in the second parameter set; and determine the priority level of each reconstructed frame based on the differences.

The at least one instruction, when executed by the at least one processor, may further cause the electronic device to: obtain a temporal identifier (ID) for each of the plurality of reconstructed frames, wherein the temporal ID corresponds to a sequence including each reconstructed frame; and determine the priority level of each reconstructed frame based on the temporal ID.

The plurality of reconstructed frames may include high priority level frames and low priority level frames, wherein the high priority level frames have a higher priority level than the low priority level frames, and the at least one instruction, when executed by the at least one processor, may further cause the electronic device to: generate a loss value using a weighted loss-function, wherein the weighted loss-function is modulated to be influenced more by one or more patches extracted from the high priority level frames than one or more patches extracted from the low priority level frames; and train the AI-based in-loop filter based on the loss value.

In accordance with an aspect of the disclosure, a non-transitory computer readable medium storing which, when executed by at least one processor of a device for processing a video, cause the device to: obtain a plurality of reconstructed frames associated with a compressed video; determine a priority level of each reconstructed frame from among the plurality of reconstructed frames; extract a set of patches from the plurality of reconstructed frames; and obtain an artificial intelligence (AI)-based in-loop filter trained based on at least one of the set of patches and the priority level.

### BRIEF DESCRIPTION OF THE DRAWINGS

The above and other features, aspects, and advantages of certain embodiments of the present disclosure will be more apparent from the following description taken in conjunction with the accompanying drawings, in which:

FIG. 1 illustrates a block diagram of a conventional solution for removing one or more artifacts from a video, according to an embodiment;

FIG. 2 illustrates a block diagram of an electronic device for removing the one or more artifacts from the video, according to an embodiment;

FIG. 3 illustrates a block diagram of a plurality of modules of the electronic device at an electronic device for removing the one or more artifacts from the video, according to an embodiment;

FIG. 4 is a block diagram for depicting the flow of removing the one or more artifacts from the video, according to an embodiment;

FIG. 5 is a block diagram for depicting the flow of removing the one or more artifacts from the video, according to an embodiment;

FIG. 6A is a block diagram for depicting an architecture of an Artificial Intelligence (AI)-based in-loop filter, according to an embodiment;

FIG. 6B is an exemplary graph depicting a comparison between complexity and prediction error of the AI-based in-loop filter, according to an embodiment;

FIGS. 7A-7B illustrate block diagrams depicting an operation of determining a priority level of each of a plurality of reconstructed frames, according to an embodiment;

FIG. 7C illustrates a schematic representation depicting the operation of the determining the priority level of each of the plurality of reconstructed frames, according to an embodiment;

FIGS. 8A-8B illustrate exemplary graphs depicting an operation of the determining the priority level of each of the plurality of reconstructed frames, according to an embodiment;

FIG. 9 is a schematic representation depicting the working of extracting a set of patches from the plurality of reconstructed frames, according to an embodiment;

FIG. 10 illustrates a block diagram depicting the operation of training the AI-based in-loop filter based on the generated loss value, according to an embodiment; and

FIG. 11 illustrates a process flow diagram depicting a method for removing the one or more artifacts from the video, according to an embodiment.

Further, skilled artisans will appreciate that those elements in the drawings are illustrated for simplicity and may not have necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the present disclosure, reference is made below to various embodiments, and specific language is used to describe the same. It should be understood that no limitation of the scope of the disclosure is thereby intended, and that the scope of the disclosure includes such alterations and further modifications to the described and illustrated embodiments, and such further applications of the principles of the disclosure as illustrated and described therein, as would normally occur to one of ordinary skill in the art to which the disclosure relates.

It will be understood by those of ordinary skill in the art that the description included herein are explanatory, and are not intended to be restrictive or limiting.

Reference throughout the present disclosure to “an aspect”, “another aspect” or similar language may mean that a particular feature, structure, or characteristic described herein is included in at least one embodiment of the present disclosure. Thus, recitations of the phrase “in an embodiment”, “in another embodiment” and similar language throughout the present disclosure may all refer to the same embodiment, but embodiments are not limited thereto.

The terms “comprises”, “comprising”, or any other variations thereof, are intended to cover a non-exclusive inclusion, such that a process or method that is described as comprising a list of steps is not intended to include only those steps, and may also include other steps not expressly listed or inherent to such process or method.

Similarly, one or more devices or sub-systems or elements or structures or components preceded by “comprises . . . a” does not, preclude the existence of other devices or other sub-systems or other elements or other structures or other components or additional devices or additional sub-systems or additional elements or additional structures or additional components, unless explicitly described otherwise.

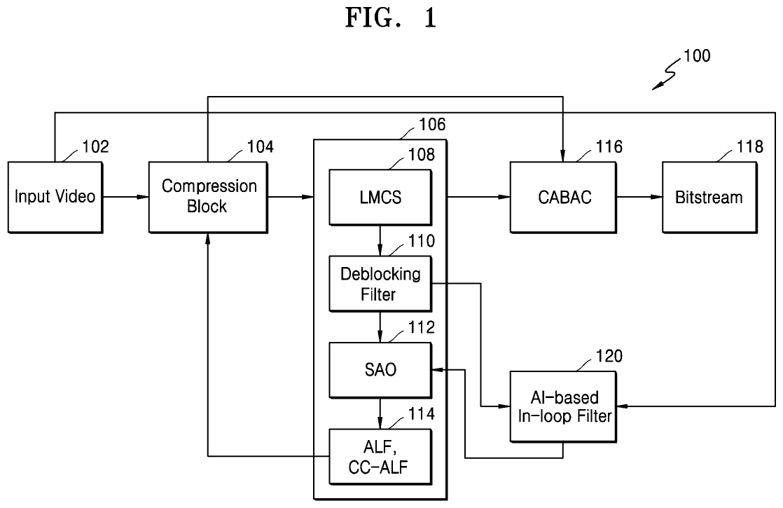

FIG. 1 illustrates a block diagram of a solution for removing or declining one or more artifacts from a video, according to a comparative example. FIG. 1 shows an example of a Versatile Video Coding (VVC) encoder 100. VVC may refer to a software and/or hardware implementation for compressing raw video data into the VVC format. The VVC encoder 100 may analyze the video content, remove redundancies, and apply various compression techniques to produce a compressed video bitstream. Further, a VVC standard corresponding to the VVC encoder 100 may follow a block-based hybrid video coding architecture. An input video 102 compressed using the VVC standard may be further processed using at least one of intra-frame prediction, inter-frame prediction, transformation, quantization, inverse transformation, and de-quantization. Further, the input video 102 may also be processed using in-loop filters 106 (which may be, for example, non-AI based filters), such as at least one of a Luma Mapping with Chroma Scaling (LMCS) filter 108 (which may also be referred to as an inverse luma mapping filter), a de-blocking filter 110, a Sample Adaptive Offset (SAO) filter 112, an Adaptive Loop Filter (ALF) and Chroma Component (CC)-ALF 114. Further, the input video 102 may be processed using entropy coding, such as Context-based Adaptive Binary Arithmetic Coding (CABAC) 116. In FIG. 1, in conformance to VVC architecture, both encoder and decoder processing is depicted.

In embodiments, according to the encoder processing, each frame of the input video 102 may be split into block-based regions, called Coding Tree Units (CTUs), using a VVC block partitioning process. The first frame of the input video 102 may be encoded using only intra-frame prediction. For all remaining frames of a sequence or between random access points, inter-frame prediction may be used. Furthermore, a residual signal of the intra or inter-frame prediction, which may be the difference between the original block and its prediction, may be converted into a frequency domain by a linear spatial transform. In quantization, transform coefficients may then be scaled and quantized. Further, in CABAC 116, the quantized coefficients may be entropy-coded using CABAC technique and transmitted along with prediction information as bit-stream 118 (which may be, for example, input to a decoder).

Furthermore, in decoder processing, the encoder may duplicate a decoder processing loop, such that identical predictions may be generated for subsequent data. In de-quantization and inverse transformation, the quantized transform coefficients may be constructed by inverse scaling (e.g., de-quantization) and may then be inverse transformed to duplicate the decoded approximation of a residual signal. Further, the residual may then be added to the prediction to generate reconstructed frames. These frames may then be fed into the loop filters 106 (including the de-blocking filter 110, the SAO filter 112, and the ALF and CC-ALF 114) to smooth out artifacts induced by block-wise processing and quantization.

The output of the in-loop filter/decoder may be stored in a decoded picture buffer to be used in the encoder processing for the prediction of subsequent pictures. Further, an AI-based In-loop filter 120 is added between a de-blocking filter 110 and the SAO filter 112. Therefore, the AI-based in-loop filter 120 may receive the reconstructed frames corrected by the de-blocking filter as input. The output of the AI-based in-loop filter 120 may be fed into the SAO filter 112 for further artifact correction. In this approach, irrespective of a frame's importance, an equal number of patches may be extracted to form or be included in the training data for the AI-based in-loop filter. Thus, this approach may consume a large amount of training time and occupy large memory and computation resources.

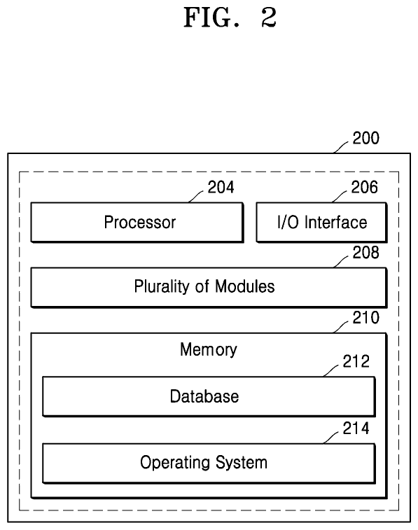

FIG. 2 illustrates a block diagram of an electronic device 200 for removing or declining one or more artifacts from a video, according to an embodiment of the present disclosure. In an embodiment of the present disclosure, the one or more artifacts may correspond to undesirable visual distortions or anomalies that appear in an image as a result of various processes, such as image acquisition, compression, transmission, or processing. The one or more artifacts may degrade image quality and affect the accuracy of image analysis or interpretation. For example, the one or more artifacts may include block discontinuities, ringing artifacts, mosquito noise, and the like. Examples of the electronic device 200 may include, but are not limited to, a smartphone, a laptop, a camera device, a smartwatch, and the like.

The electronic device 200 may include at least one processor 204, an input/output (I/O) interface 206, a plurality of modules 208, and a memory 210.

In an exemplary embodiment, the at least one processor 204 may be operatively coupled to each of the respective I/O interface 206, the plurality of modules 208, and the memory 210. In one embodiment, the at least one processor 204 may include at least one data processor for executing processes in Virtual Storage Area Network. The at least one processor 204 may include specialized processing units such as integrated system (bus) controllers, memory management control units, floating point units, graphics processing units, digital signal processing units, etc. In one embodiment, the at least one processor 204 may include a Central Processing Unit (CPU), a Graphics Processing Unit (GPU), or both. The at least one processor 204 may be one or more general processors, digital signal processors, application-specific integrated circuits, field-programmable gate arrays, servers, networks, digital circuits, analog circuits, combinations thereof, or other now known or later developed devices for analyzing and processing data. The at least one processor 204 may execute a software program, such as code generated manually (i.e., programmed) to perform the desired operation. In an embodiment of the present disclosure, the at least one processor 204 may be a general purpose processor, such as the CPU, an Application Processor (AP), or the like, a graphics-only processing unit such as the GPU, a Visual Processing Unit (VPU), and/or an artificial intelligence (AI)-dedicated processor, such as a Neural Processing Unit (NPU).

Further, the at least one processor 204 may control the processing of input data in accordance with a predefined operating rule or machine learning (ML) model stored in the non-volatile memory and the volatile memory. The predefined operating rule or the ML model may be provided through training or learning.

Here, being provided through learning may mean that, by applying a learning technique to a plurality of learning data, a predefined operating rule or the ML model of a desired characteristic is made. The learning may be performed in a device itself in which ML according to an embodiment is performed, and/or may be implemented through a separate server/system.

Furthermore, the ML model may include a plurality of neural network layers. Each layer has a plurality of weight values and performs a layer operation through a calculation of a previous layer and an operation of a plurality of weights. Examples of neural networks include, but are not limited to, Convolutional Neural Network (CNN), Deep Neural Network (DNN), Recurrent Neural Network (RNN), Restricted Boltzmann Machine (RBM), Deep Belief Network (DBN), Bidirectional Recurrent Deep Neural Network (BRDNN), Generative Adversarial Networks (GAN), and deep Q-network.

The learning technique may refer to a process for training a predetermined target device (for example, a robot) using a plurality of learning data to cause, allow, or control the target device to make a determination or prediction. Examples of learning techniques may include at least one of supervised learning, unsupervised learning, semi-supervised learning, or reinforcement learning, but embodiments are not limited thereto.

The at least one processor 204 may be disposed in communication with one or more input/output (I/O) devices using the respective I/O interface 206. The I/O interface 206 may employ communication code-division multiple access (CDMA), high-speed packet access (HSPA+), global system for mobile communications (GSM), long-term evolution (LTE), WiMax, or the like, etc.

The at least one processor 204 may communicate with a communication network using a network interface. In an embodiment, the network interface may be the I/O interface 206. The network interface may connect to the communication network to enable the connection of the electronic device 200 with other electronic devices. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network may include at least one of a direct interconnection, local area network (LAN), wide area network (WAN), wireless network (e.g., using Wireless Application Protocol), the Internet, and the like, but embodiments are not limited thereto.

In an embodiment of the present disclosure, the at least one processor 204 may be configured to receive, from one or more codec blocks, a plurality of reconstructed frames associated with a compressed video. The plurality of reconstructed frames may include the one or more artifacts. The at least one processor 204 may be also configured to determine a priority level and/or an importance level (IL) of each of the received plurality of reconstructed frames. Further, the at least one processor 204 may be configured to extract a set of patches from the received plurality of reconstructed frames based on the determined priority level and a patch extraction criteria. Furthermore, the at least one processor 204 may be configured to provide an AI-based in-loop filter based on the extracted set of patches and the compressed video for removing or declining the one or more artifacts from the compressed video.

In some embodiments, the memory 210 may be communicatively coupled to the at least one processor 204. The memory 210 may be configured to store data, and instructions executable by the at least one processor 204. The memory 210 may include a least one of a non-transitory computer-readable storage media, such as various types of volatile and non-volatile storage media which may include at least one of random access memory, read-only memory, programmable read-only memory, electrically programmable read-only memory, electrically erasable read-only memory, flash memory, magnetic tape or disk, optical media and the like, but embodiments are not limited thereto. In one example, the memory 210 may include a cache or random-access memory for the at least one processor 204. As another examples, the memory 210 may be a part of the at least one processor 204, such as a cache memory of a processor, the system memory, or other memory. In some embodiments, the memory 210 may be an external storage device or a database 212 for storing data. The memory 210 may be operable to store instructions executable by the at least one processor 204. The functions, acts, or tasks illustrated in the figures or described may be performed by the at least one processor 204 for executing the instructions stored in the memory 210. The functions, acts or tasks may be independent of the particular type of instruction set, storage media, processor, or processing strategy and may be performed by software, hardware, integrated circuits, firmware, micro-code, and the like, operating alone or in combination. Likewise, processing strategies may include multiprocessing, multitasking, parallel processing, and the like.

In some embodiments, the plurality of modules 208 may be included within the memory 210. The memory 210 may further include a database 212 to store data. The plurality of modules 208 may include a set of instructions that may be executed to cause the electronic device 200 to perform any one or more of the methods and processes disclosed herein. The plurality of modules 208 may be configured to perform the steps of the present disclosure using the data stored in the database 212 for correcting the one or more artifacts from the video, as discussed herein. In an embodiment, each of the plurality of modules 208 may be a hardware unit that may be outside the memory 210. Further, the memory 210 may include an operating system 214 for performing one or more tasks of the electronic device 200, as performed by a generic operating system in the communications domain. In one embodiment, the database 212 may be configured to store the information as required by the plurality of modules 208 and the at least one processor 204 for removing or declining the artifacts from the video.

In an embodiment of the present disclosure, at least one of the plurality of modules 208 may be implemented through or using the ML model. For example, a function associated with the ML model may be performed through or using the non-volatile memory, the volatile memory, and the at least one processor 204.

In an embodiment, the I/O interface 206 may enable input and output to and from the electronic device 200 using suitable devices such as at least one of a display, a keyboard, a mouse, a touch screen, a microphone, a speaker, and so forth, but embodiments are not limited thereto.

Further, the present disclosure also contemplates a computer-readable medium that includes instructions or receives and executes instructions responsive to a propagated signal. Further, the instructions may be transmitted or received over the network using a communication port or interface or using a bus. The communication port or interface may be a part of the at least one processor 204 or may be a separate component. The communication port may be created in software or may be a physical connection in hardware. The communication port may be configured to connect with a network, external media, the display, or any other components in the electronic device 200, or combinations thereof. The connection with the network may be a physical connection, such as a wired Ethernet connection, or may be established wirelessly. Likewise, the additional connections with other components of the electronic device 200 may be physical or may be established wirelessly. In some embodiments, the network may be directly connected to the bus. For the sake of brevity, the architecture, and standard operations of the operating system 214, the memory 210, the database 212, the at least one processor 204, and the I/O interface 206 are not discussed in detail.

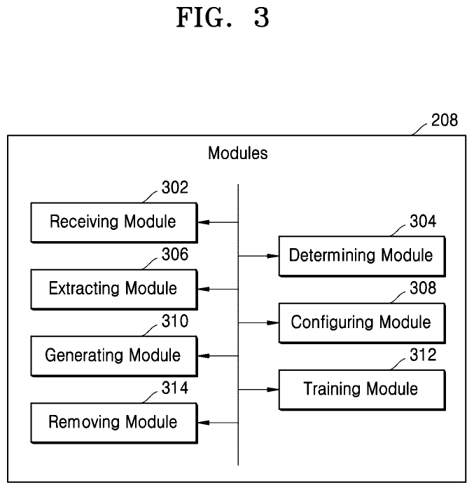

FIG. 3 illustrates a block diagram of the plurality of modules 208 of the electronic device 200 for removing or declining the one or more artifacts from the video, according to an embodiment of the present disclosure. In an embodiment of the present disclosure, the plurality of modules 208 may include a receiving module 302, a determining module 304, an extracting module 306, a configuring module 308, a generating module 310, a training module 312, and a removing module 314, but embodiments are not limited thereto. The plurality of modules 208 may be implemented using suitable hardware and/or software applications.

In an embodiment of the present disclosure, the receiving module 302 may be configured to receive, from one or more codec blocks, a plurality of reconstructed frames associated with a compressed video. In an embodiment of the present disclosure, the plurality of reconstructed frames includes the one or more artifacts. The one or more codec blocks are fundamental units into which a video frame is divided during an encoding and decoding process. The one or more codec blocks are the building blocks used by video codecs to efficiently represent video data and achieve compression. For example, the one or more codec blocks may include in-loop filters, a LMCS filter, a deblocking filter, and the like. In an embodiment of the present disclosure, the plurality of reconstructed frames in video compression may refer to the frames that are generated during a decoding process after the video has been compressed. Examples of details of the generation of reconstructed frames are described above with reference to at least FIG. 1.

Further, the determining module 304 may be configured to determine a priority level of each of the received plurality of reconstructed frames. In determining the priority level of each of the plurality of reconstructed frames, the determining module 304 may be configured to determine a first set of Bjontegaard Delta Bitrate (BD-BR) gains associated with the plurality of reconstructed frames by using a video codec encoder and turning off one or more in-loop filters. In an embodiment of the present disclosure, the one or more in-loop filters (e.g., deblocking filters or post-processing filters) may be related to a type of image processing technique used to improve the visual quality of compressed images. These one or more in-loop filters may be applied during the decoding process of a compressed image or video to reduce compression artifacts and enhance image quality. Further, the determining module 304 may be configured to determine a second set of BD-BR gains associated with the plurality of reconstructed frames by using the video codec encoder and the one or more in-loop filters. The determining module 304 may further be configured to calculate a difference between each of the determined first set of BD-BR gains and each of the determined second set of BD-BR gains. Furthermore, the determining module 304 may be configured to determine the priority level of each of the plurality of reconstructed frames based on the calculated differences. In an exemplary embodiment of the present disclosure, the frames with highest difference may have the maximum priority.

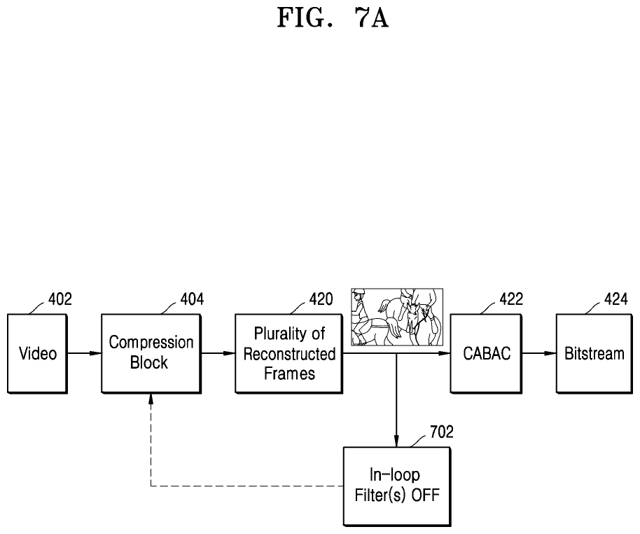

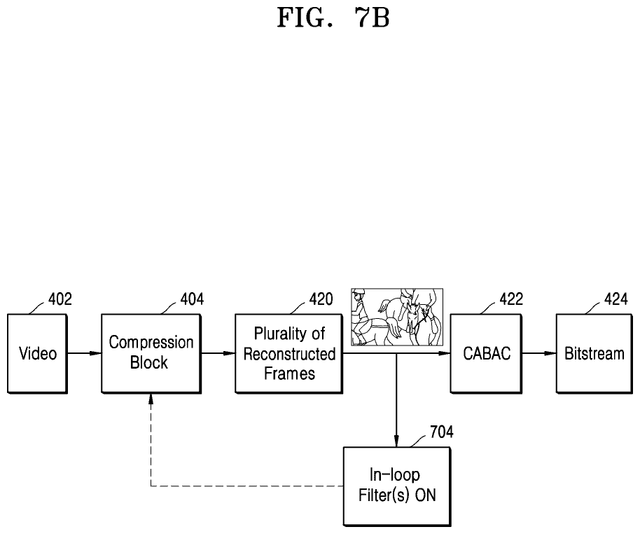

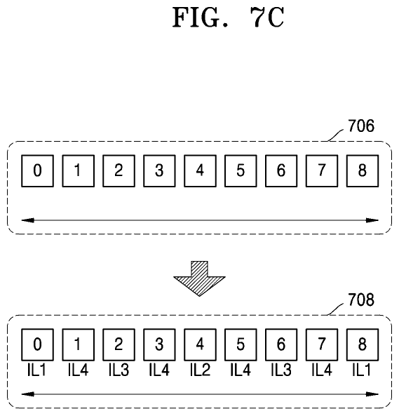

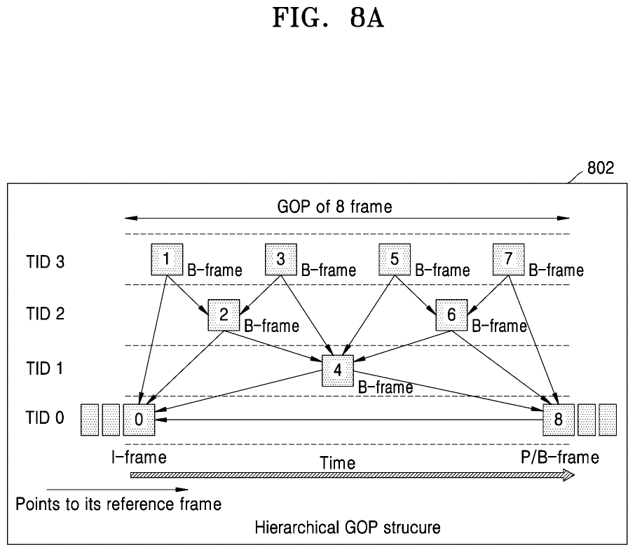

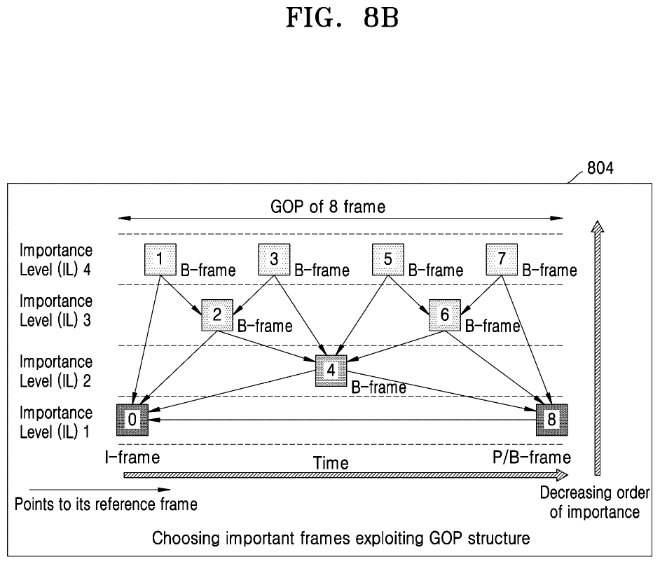

In an embodiment of the present disclosure, in determining the priority level of each of the plurality of reconstructed frames, the determining module 304 may be configured to obtain a temporal identifier (ID) for each of the plurality of reconstructed frames. In an embodiment of the present disclosure, the temporal ID may correspond to a sequence in which a respective reconstructed frame is encoded by the video codec encoder. Further, the determining module 304 may be configured to determine the priority level of each of the plurality of reconstructed frames based on the obtained temporal ID. In an embodiment of the present disclosure, the temporal ID assignment may be a part of a codec pipeline. The information regarding which frame is to be encoded at what time, may be predetermined. This information may be present in a configuration file associated with every encoding-decoding process. Examples of details about the operation of determining module 304 for determining the priority level of each of the plurality of reconstructed frames are described below with reference to at least FIGS. 7A-7C and FIGS. 8A-8B.

In an embodiment of the present disclosure, the generating module 310 may be configured to receive one or more characteristics associated with the AI-based in-loop filter from a user. In an exemplary embodiment of the present disclosure, the one or more characteristics of the AI-based in-loop filter may include a size, complexity, an application of the AI-based in-loop filter, and the like. Further, the generating module 310 may be configured to generate the patch extraction criteria for extracting the set of patches based on the received one or more characteristics.

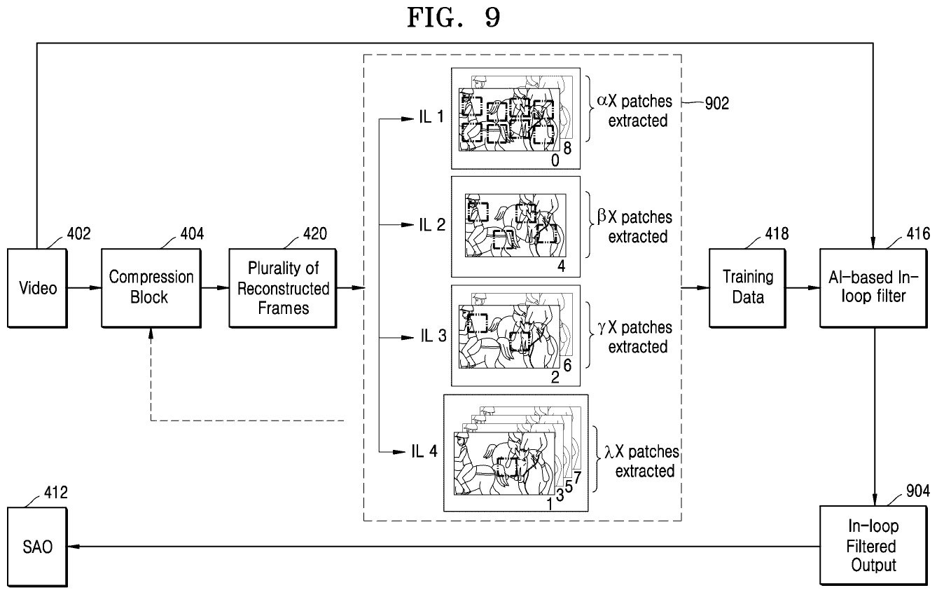

Further, the extracting module 306 may be configured to extract a set of patches from the received plurality of reconstructed frames based on the determined priority level and a patch extraction criteria. In extracting the set of patches, the extraction module may be configured to extract a first set of patches from a first set of reconstructed frames from among the plurality of reconstructed frames. In an embodiment of the present disclosure, each of the first set of reconstructed frames may have a first priority level. Further, the extraction module may be configured to extract a second set of patches from a second set of reconstructed frames amongst the plurality of reconstructed frames. In an embodiment of the present disclosure, the each of the second set of reconstructed frames may have a second priority level. The first priority level may be more than the second priority level. In an embodiment of the present disclosure, a number of the first set of reconstructed frames may be more than a number of the second set of reconstructed frames. Examples of details about the operation of extracting module 306 for extracting the set of patches from the received plurality of reconstructed frames are described below with reference to at least FIG. 9.

Further, the configuring module 308 may be configured to provide an AI-based in-loop filter based on the extracted set of patches and the compressed video for removing or declining the one or more artifacts from the compressed video. In configuring the AI-based in-loop filter, the configuring module 308 may be configured to determine a priority of each of the extracted set of patches based on the determined priority level and the patch extraction criteria. Further, the configuring module 308 may be configured to provide the AI-based in-loop filter based on the extracted set of patches, the compressed video, and the determined priority level of each of the extracted set of patches.

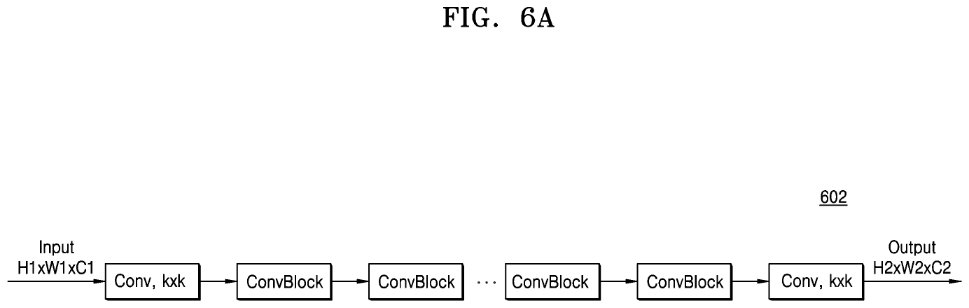

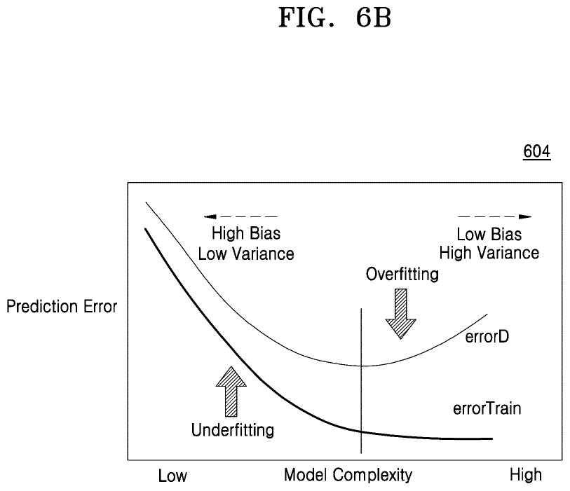

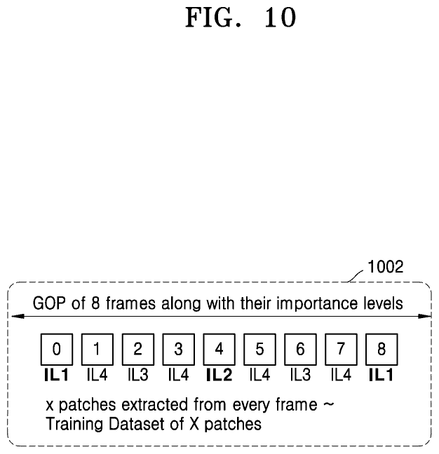

In an embodiment of the present disclosure, before using the AI-based in-loop filter, the AI-based in-loop filter may be trained. The training module 312 may be configured to extract a plurality of patches of fixed sizes from each of the plurality of reconstructed frames. Further, the training module 312 may be configured to generate a loss value corresponding to each of the plurality of patches based on the priority level of each of the plurality of reconstructed frames and one or more patches extracted from an original video by using a weighted loss-function. In an embodiment of the present disclosure, the weighted loss-function may penalize one or more patches more in comparison to one or more other patches of the plurality of patches. The one or more patches may be patches from among the plurality of patches which are extracted from high priority level frames of the plurality of reconstructed frames. Further, the training module 312 may be configured to train the AI-based in-loop filter based on the generated loss value. In an embodiment of the present disclosure, the trained AI-based in-loop filter may be a low complexity neural network-based model as compared to other neural network-based models that may be used to identify artifacts. The low complexity neural network-based model may be designed to rectify various types of compression artifacts. This AI-based in-loop filter may have a reduced or minimal number of parameters, which may make it device-friendly. Examples of details about the AI-based in-loop filter are described below with reference to at least FIGS. 6A and 6B. In addition, examples of details about the operation of training module 312 for training the AI-based in-loop filter are described below with reference to at least FIG. 10.

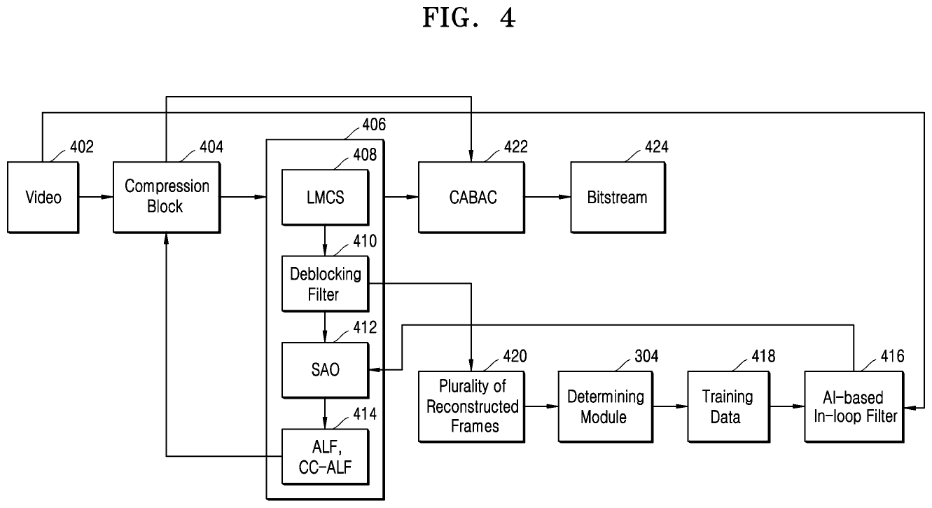

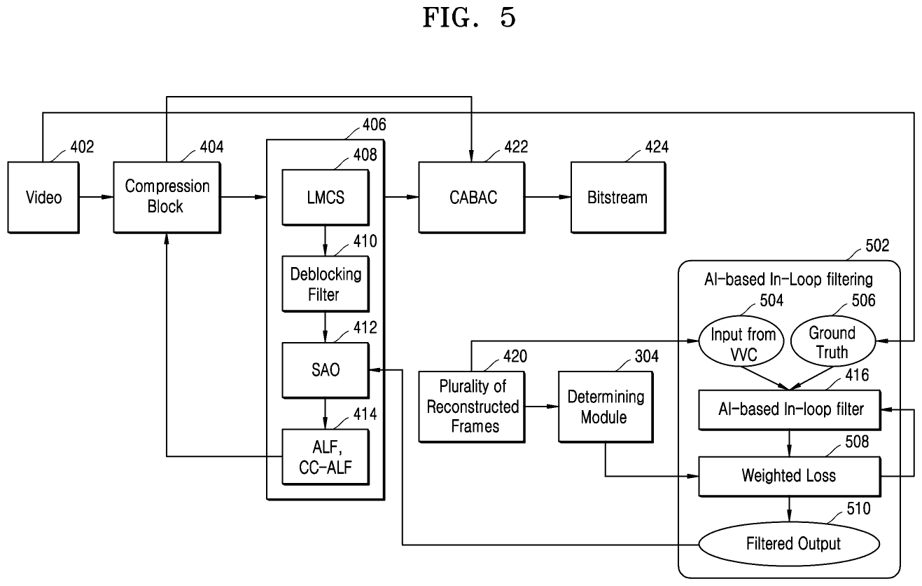

Further, the removing module 314 may be configured to identify the one or more artifacts in the plurality of reconstructed frames of the compressed video by using the AI-based in-loop filter upon configuring the AI-based in-loop filter. In addition, the removing module 314 may be configured to remove the identified one or more artifacts from the plurality of reconstructed frames by using the AI-based in-loop filter. In an embodiment of the present disclosure, enhanced quality video frames are fed back to the VVC pipeline upon removing the identified one or more artifacts. Examples of details about the operation of the electronic device 200 for removing the one or more artifacts from the video are provided below with reference to at least FIGS. 4 and 5.

FIG. 4 is a block diagram for depicting a process flow for removing the one or more artifacts from the video, according to an embodiment of the present disclosure. The process flow for removing the one or more artifacts from the video may be performed by the electronic device 200 described above with reference to FIG. 3.

As shown in FIG. 4, the video 402 compressed using a VVC encoder may be further processed using intra-frame prediction, inter-frame prediction, transformation, inverse transformation quantization, and de-quantization by the compression block 404. Further, the input video may also be processed using the one or more in-loop filters 406 (which may be, for example, non-AI in-loop filters), such as an LMCS filter 408, a de-blocking filter 410, an SAO filter 412, and a CC-ALF 414. As shown in FIG. 4, the AI-based in-loop filter 416 may be placed between the de-blocking filter 410 and the SAO filter 412. Therefore, the electronic device 200 may generate the training data 418 for the AI-based in-loop filter 416 from the plurality of reconstructed frames 420 which have been processed by the LMCS filter 408 and the de-blocking filter 410. In an embodiment of the present disclosure, the location from which the training data 418 may be captured may vary depending on the placement of the AI-based in-loop filter 416 in the flow. In an embodiment of the present disclosure, the training data 418 for the AI-based in-loop filter 416 may be also generated using a different video codec data flow. Moreover, the different video codec data flow may also be modified to execute different kinds of objectives by using the training data 418.

In an embodiment of the present disclosure, the plurality of reconstructed frames 420 processed by the de-blocking filter 410 may be first passed through the determining module 304, where each of the plurality of reconstructed frames 420 may be mapped to its importance/priority level and the priority level of each of the plurality of reconstructed frames 420 may be determined. Further, the user may define a patch extraction criteria based on the model complexity of the AI-based in-loop filter 416 and the application. Further, the electronic device 200 may use the patch extraction criteria to extract fixed-size patches from the plurality of reconstructed frames 420 based on determined priority level. For example, if the AI-based in-loop filter 416 is the low-complexity model, it may be desired to train the AI-based in-loop filter 416 with only relevant training data for better generalization. Therefore, the patch extraction criteria may be defined in the following manner: more patches may be extracted from the plurality of reconstructed frames with higher priority levels as compared to lower priority level frames. For example, the reconstructed frames with higher priority may be frames with a priority level of one (“1”) and reconstructed frames with lower priority may be frames with priority level of two (“2”) Further, lower priority level frames may have nearly negligible impact on the compression gain, and therefore lower priority level frames (“1”) not included in the training data 418. The plurality of patches finally included in the training data 418 which may be used to provide the AI-based in-loop filter 416. The AI-based in-loop filter 416 may also receive an original video sequence as input during training.

Further, after training the AI-based in-loop filter 416 with regular L1/L2 loss and inference, AI-filtered output (e.g., video without one or more artifacts) may be fed back to the SAO filter in a VVC pipeline. In an embodiment of the present disclosure, the video may also also processed using entropy coding, such as CABAC 422 to generate a bitstream of data 424.

FIG. 5 is a block diagram for depicting a process flow for removing the one or more artifacts from the video, according to an embodiment of the present disclosure. The process flow for removing the one or more artifacts from the video may be performed by the electronic device 200 described above with reference to FIG. 3.

As depicted in FIG. 5, the flow of removing the one or more artifacts from the video is similar to the flow depicted in FIG. 4. However, in place of using the patch extraction criteria, a brute-force patch extraction may be used. In the brute-force patch extraction, the priority level of each of the plurality of reconstructed frames 420 may not be considered during the patch extraction. Rather, the plurality of patches of fixed sizes may be extracted from each of the plurality of reconstructed frames 420. In AI-based in-loop filtering 502, the plurality of patches may be included in the training data 418 for the AI-based in-loop filter labelled as input from VVC 504. The AI-based In-loop filter 416 may also receive the original video sequence as input during training labelled as ground-truth 506. In an embodiment of the present disclosure, the AI-based in-loop filters may be designed to combat various kinds of compression artifacts. The decisions from such in-loop filters may be in-loop (e.g., they may affect decisions for future frames as well). Further, a weighted loss module 508 may be used for generating the loss value corresponding to each of the plurality of patches based on the priority level of each of the plurality of reconstructed frames 420 and the one or more patches extracted from the original video by using the weighted loss-function. With every patch, additional metadata may be present which may facilitate determining which patch is extracted from which importance level. The input patches which are extracted from high importance level frames may be penalized more in comparison to other patches. For example, patches extracted from IL 1 frames may be penalized with higher weights as compared to patches extracted from IL 2, 3 or 4. Here IL 1 may refer to importance level one (“1”), or the most important frames or most prioritized frame. Therefore, an input to the weighted loss module 508 may be the plurality of reconstructed frames 420 ranked according to their importance level, one (“1”) being the highest importance level, which may correspond to ground-truth frame from the original video. The output of the weighted loss module 508 may be the loss value calculated by the weighted loss function (e.g., L1/L2 loss), which is used to train the AI-based in-loop filter. After training the AI-based in-loop filter with weighted L1/L2 loss and inference, the AI-filtered output may be fed back to the SAO block or SAO filter in the VVC pipeline. Further, a filtered output 510 (video without artifacts) may be outputted to the SAO filter 412.

FIG. 6A is a block diagram for depicting an architecture 602 of the AI-based in-loop filter, according to an embodiment of the present disclosure. FIG. 6B is an exemplary graph 604 depicting a comparison between complexity and prediction error of the AI-based in-loop filter, according to an embodiment of the present disclosure. For the sake of brevity, FIG. 6A and FIG. 6B are explained together. The details on the AI-based in-loop filter are explained in FIG. 3.

As depicted in the architecture 602 of the AI-based in-loop filter, the AI-based in-loop filter may be a low complexity neural network-based model designed to rectify various types of compression artifacts. The AI-based in-loop filter may have a minimal number of parameters which may make the AI-based in-loop filter device-friendly. Due to the constraint on the number of parameters, such low-complexity AI-based in-loop filter may be unable to capture all the necessary intricacies of the data. Low-complexity AI-based in-loop filters may suffer from under-fitting hence they are not good at generalizing well over the data. If the complexity of the AI-based in-loop filters is lower, this may mean there are less learnable parameters thus less learning capacity of the AI-based in-loop filters. Such AI-based in-loop filters may suffer from under fitting as they may fail to capture the full variation in the data. Therefore, to enhance the learning capabilities of the AI-based in-loop filter, refinement of the training dataset may be performed, as discussed above with reference to in FIGS. 4 and 5.

Further, as depicted in graph 604 of FIG. 6B, the AI-based in-loop filter may undergo underfitting if a prediction error is high and model complexity is low, or may undergo overfitting if the prediction error is low and the model complexity is high. In an embodiment of the present disclosure, the prediction error corresponds to artifacts. A greater number of artifacts indicates more prediction error. In an embodiment of the present disclosure, the artifacts are caused by prediction error.

FIGS. 7A-7B illustrate block diagrams depicting an operation of determining a priority level of each of a plurality of reconstructed frames, according to an embodiment of the present disclosure. Further, FIG. 7C illustrates a schematic representation depicting the operation of the determining module 304 for determining the priority level of each of the plurality of reconstructed frames, according to an embodiment of the present disclosure. For the sake of brevity, FIGS. 7A-7C are explained together. The operation of the determining module 304 is explained in detail with reference to at least FIG. 4.

As depicted in FIG. 7A, the video 402 may be inputted to the compression block 404 for performing one or more operations, such as transformation, quantization, de-quantization, inverse-transform, and the like in the compression block 404. Further, the plurality of reconstructed frames 420 may be obtained. Furthermore, the first set of BD-BR gains associated with the plurality of reconstructed frames may be determined using the video codec encoder and turning off the one or more in-loop filters, at block 702. For example, if there are nine frames in a GOP, the first set of BD-BR gains (e.g., a0, a1, . . . , a8) may be determined for all the nine frames. In an embodiment of the present disclosure, the video may also be processed using entropy coding, such as CABAC.

Similarly, as depicted in FIG. 7B, the second set of BD-BR gains associated with the plurality of reconstructed frames are determined by using the video codec encoder and turning on the one or more in-loop filters, at block 704. For example, if there are nine frames in the GOP, the second set of BD-BR gains (e.g., b0, b1, . . . , b8) are determined for all the nine frames. In an exemplary embodiment of the present disclosure, the first set of BD-BR gains and the second set of BD-BR gains may be represented in percentage form. Further, a difference may be calculated between each of the determined first set of BD-BR gains and each of the determined second set of BD-BR gains. For example, the calculated difference (e.g., d0, d1, . . . , d8) is such that di=bi−ai, where “i” may denote an index that varies from zero (“0”) to eight (“8”) for a GOP structure of nine (“9”). Further, frames may be ranked based on the calculated differences. For example, frames that have higher differences may have a higher impact on the final BD-rate gain, those frames may be categorized as important frames. Based on the ranking, importance levels may be defined. For example, highly relevant or important frames such as the I-frame which may be used as reference for every other frame may be assigned the highest importance level.

Furthermore, as depicted in FIG. 7C, after applying the determining module 304 on a GOP of nine frames in linear order (as shown in block 706), each frame may be associated with its own importance level. Block 708 represents the GOP of nine frames along with their importance levels determined by the determining module 304. At block 708, IL 1 may refer to the most important frames, whereas IL 4 frames may be the least important.

FIGS. 8A-8B illustrate exemplary graphs depicting an operation of the determining module 304 for determining the priority level of each of the plurality of reconstructed frames, according to an embodiment of the present disclosure. The operation of the determining module 304 is explained in detail with reference to at least FIG. 4.

As depicted in graph 802 of FIG. 8A, a GOP of nine frames is shown in a hierarchal order. In the GOP hierarchy, the frames implicitly follow a temporal ordering. For example, frames associated with temporal ID 0 may be encoded first, followed by frames associated with subsequent temporal IDs 1, 2, and 3. In an embodiment of the present disclosure, the determining module 304 may also exploit the temporal IDs of each frame along with the impact of each frame on the final BD-rate gain to assign an importance level to every frame. For example, in graph 804 of FIG. 8B, frames associated with temporal ID 0 may be used as a reference for all other frames, and therefore its impact on the final BD-rate gain may be relatively, and therefore IL 1 may be assigned to such frames.

In an embodiment, the electronic device 200 may obtain temporal ID for each of the plurality of reconstructed frames, wherein the temporal ID may correspond to a sequence including each reconstructed frame included in the plurality of reconstructed frames. The electronic device 200 may determine the priority level of each reconstructed frame included in the plurality of reconstructed frames based on the obtained temporal ID.

FIG. 9 is a schematic representation depicting the working of the extracting module 306 for extracting the set of patches from the plurality of reconstructed frames, according to an embodiment of the present disclosure. An example of the operation of the extracting module 306 is explained in detail with reference to at least FIG. 4.

As shown in FIG. 9, the video 402 is inputted to the compression block 404 and the plurality of reconstructed frames 420 are obtained. In the current scenario, the video includes a GOP of nine frames. Further, the extracting module 306 may be a training data collection module for the AI-based in-loop filter 416. Further, the extracting module 306 may follow a selection criterion that may be dependent on the complexity of the AI-based in-loop filter and the importance level of every frame calculated by the determining module 304. For example, at block 902, αX patches may be extracted from frames corresponding to IL 1, βX, γX, λX patches may be extracted from frames corresponding to IL 2, IL 3 and IL 4, respectively, where α>>β>>γ>>λ. In the current example, IL 1 frames may be the most important, and therefore their share in the training data 418 may be the highest. The output of the extracting module 306 (e.g., fixed size patches weighted according to the importance level of the frames) may be included in the training data 418 to perform the AI-based in-loop filtering. Further, a final in-loop filtered output 904 may be outputted to the SAO filter 412 for continuing operations in the VVC pipeline.

FIG. 10 illustrates a block diagram depicting the operation of a training module 312 training the AI-based in-loop filter based on the generated loss value, according to an embodiment of the present disclosure. Examples of the operation of the training module 312 are explained in detail with reference to at least FIG. 4.

As depicted in FIG. 10, block 1002 shows a GOP of 8 frames along with their importance levels. Further, the training module 312 may be the proposed loss calculation module for training AI-based in-loop filters. In an embodiment of the present disclosure, the input patches which are extracted from high importance level frames may be penalized more in comparison to other patches. For example, patches extracted from IL 1 frames (x¹) may be penalized with higher weights (w¹) as compared to patches extracted from IL 2, 3, or 4. Further, equation (1) below may be used to calculate the total loss.

$$Loss = MSE ( X , {X}_{\{ gt \}} ) \qquad Equation 1$$

$$Loss = 1 * MSE ( {x}^{1} , {x}_{gt}^{1} ) + 1 * MSE ( {x}^{2} , {x}_{gt}^{2} ) + 1 * MSE ( {x}^{3} , {x}_{g 𝔱}^{3} ) + 1 * MSE ( {x}^{4} , {x}_{gt}^{4} )$$

$$Loss = {w}_{1} * MSE ( {x}^{1} , {x}_{gt}^{1} ) + {w}_{2} * MSE ( {x}^{2} , {x}_{g t}^{2} ) + {w}_{3} * MSE ( {x}^{3} , {x}_{gt}^{3} ) + {w}_{4} * MSE ( {x}^{4} , {x}_{gt}^{4} )$$

$$where , {w}_{1} ≫ {w}_{2} ≫ {w}_{3} ≫ {w}_{4}$$

In Equation 1 above, Loss may denote the total loss, MSE may denote mean square error, xⁱ may denote an output frame corresponding to an index i, x_{gt}ⁱ may correspond to a ground truth frame corresponding to the index i, and wᵢ may denote a weight corresponding to the index i. Although Equation 1 shows an example in which the loss is calculated using mean square error, embodiments are not limited thereto, and other techniques may be used.

In an embodiment of the present disclosure, the training module 312 may generate the loss value corresponding to each of the plurality of patches based on the priority level of each of the plurality of reconstructed frames and the one or more patches extracted from the original video by using the weighted loss-function (L1/L2 Loss). The training module 312 may train the AI-based in-loop filter based on the generated loss value.

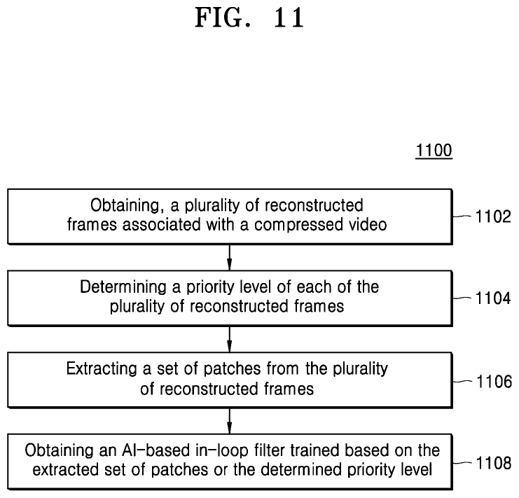

FIG. 11 illustrates a flowchart depicting a process 1100 for removing one or more artifacts from a video, according to an embodiment of the present disclosure. The process 1100 may be performed by any of the electronic devices described above, for example the electronic device 200 described above with reference to FIGS. 2 and 3.

At operation 1102, the electronic device may obtain a plurality of reconstructed frames associated with a compressed video. In an embodiment of the present disclosure, the plurality of reconstructed frames includes the one or more artifacts. The plurality of reconstructed frames may be the plurality of reconstructed frames 420 of FIG. 4 or FIG. 5.

At operation 1104, the electronic device may determine a priority level of each reconstructed frame from among the plurality of reconstructed frames.

In an embodiment, the electronic device may determine a first parameter set including first parameters associated with the plurality of reconstructed frames without using one or more in-loop filters. The electronic device may determine a second parameter set including second parameters associated with the plurality of reconstructed frames with using the one or more in-loop filters. The electronic device may calculate differences between each parameter of the determined first parameter set and each parameter of the determined second parameter set. The electronic device may determine the priority level of each of the plurality of reconstructed frames based on the calculated differences. According to embodiments, the first parameters and the second parameters may be BD-BR gains associated with the plurality of reconstructed frames.

At operation 1106, the electronic device may extract a set of patches from the plurality of reconstructed frames.

In an embodiment of the disclosure, the electronic device may extract a set of patches with fixed size from the reconstructed frames. The extracting of the set of patches may not follow any particular or predetermined criteria, and may be organically performed on the at least one of the plurality of the reconstructed frames.

In an embodiment of the disclosure, the electronic device may extract a set of patches from the plurality of reconstructed frames based on the determined priority level or patch extraction criteria. For example, depending on the determined priority level of each reconstructed frame from among the plurality of the reconstructed frames, a different number of patches may be extracted from each reconstructed frame.

In an embodiment of the disclosure, the electronic device may extract a first set of patches from a first set of reconstructed frames from among the plurality of reconstructed frames, wherein each frame included in the first set of reconstructed frames may have a first priority level. The electronic device may extract a second set of patches from a second set of reconstructed frames amongst the plurality of reconstructed frames, wherein each frame from among the second set of reconstructed frames may have a second priority level. The first priority level may be higher (e.g., more important) than the second priority level. The first priority level may be lower (e.g., less important) than the second priority level. The number of patches included in the first set may be greater than the number of patches included in the second set.

In an embodiment of the present disclosure, one or more characteristics associated with the AI-based in-loop filter may be received from a user, for example based on user input. In an exemplary embodiment of the present disclosure, the one or more characteristics of the AI-based in-loop filter may include a size, complexity, and an application of the AI-based in-loop filter. Further, the patch extraction criteria may be generated for extracting the set of patches based on the received one or more characteristics.

At operation 1108, the electronic device may obtain an AI-based in-loop filter trained based on at least one of the extracted set of patches and the determined priority level. The electronic device may obtain an artificial intelligence (AI)-based in-loop filter trained based on the extracted set of patches and the compressed video for removing the one or more artifacts from the compressed video. For obtaining the AI-based in-loop filter, the process 1100 may include determining a priority of each patch from among the extracted set of patches based on the determined priority level and the patch extraction criteria. Further, the process 1100 may include configuring the AI-based in-loop filter based on the extracted set of patches, the compressed video, and the determined priority of each of the extracted set of patches.

In an embodiment of the disclosure, the AI-based in-loop filter may be trained using the extracted set of patches.

In an embodiment of the disclosure, the electronic device may generate or obtain a loss value obtained by using a weighted loss-function. The plurality of reconstructed frames may include high priority level frames and low priority level frames, wherein the high priority level frames may have a higher priority level than the low priority level frames. The weighted loss-function may be modulated to be influenced more by one or more patches extracted from the high priority level frames than one or more patches extracted from the low priority level frames. The AI-based in-loop filter may be trained based on the generated loss value. For example, the AI-based in-loop filter may be trained to minimize the loss value. In embodiments, the loss value may be calculated according to Equation 1 above.

In an embodiment of the disclosure, the AI-based in-loop filter may be trained using the extracted set of patches extracted from the set of patches included in the plurality of reconstructed frames based on the determined priority level and the patch extraction criteria.

In an embodiment of the disclosure, the electronic device may filter the plurality of reconstructed frames of the compressed video by using the AI-based in-loop filter.

While the above steps shown in FIG. 11 are described in a particular sequence, the steps may occur in variations to the sequence in accordance with various embodiments of the present disclosure. Further, the details related to various steps of FIG. 11, which are already covered in the description related to FIGS. 1-10 are not discussed again in detail here for the sake of brevity.

Embodiments of the present disclosure relate to various technical advancements based on features discussed above. Embodiments of the present disclosure may provide techniques pertaining to an enhancement of generalization capabilities of low-complexity AI-based in-loop filter (e.g., low-complexity AI models) for video compression. Embodiments of the present disclosure may also be used to generate relevant and focused training data from the video compression pipeline by weighting frames based on its importance. Further, the present disclosure may use a lower number of models with more generalization capability specific to video codec. Embodiments of the present disclosure may leverage the importance or priority of each frame, for example during at least one of the data generation phase and during the training phase, by weighting the relevant patches with higher values. These methods and processes according to embodiments of the present disclosure may be especially helpful in boosting the generalization capability of low-complexity AI models which may not have enough parameters to capture all the intricacies of a huge dataset. Using embodiments of the present disclosure, a relatively small amount of refined training data may be generated, which may assist AI-based in-loop filters to generalize well. Thus, embodiments of the present disclosure may avoid the need for having multiple specific models for different frame types. Further, embodiments of the present disclosure may focus on increasing the learning and generalization capacity of low-complexity AI-based models without increasing the number of parameters.

According to some approaches, the usefulness of each frame may not be taken into consideration in methods and processes of generating training data for AI-based coding tools. In these approaches, an equal number of patches may be extracted from each frame, regardless of the importance of the frames, to form the training data for the AI-based model. In some cases, different models may be trained for handling data from different frames or frame positions. Thus, these approaches may consume more memory and more time.

However, embodiments of the present disclosure may calculate an importance level of a frame in the data generation phase, and may extract more patches from frames that are important (e.g., high priority level frames) as compared to other frames. Furthermore, this importance level may be utilized in the training phase by modulating the loss function, such that the patches extracted from higher importance level frames (e.g., high priority level frames) are penalized more in comparison to the patches extracted from lower importance level frames (e.g., low priority level frames). Thus, embodiments of the present disclosure may save training time and occupy lower memory and compute requirements, while generalizing well across all varieties of data. For example, the electronic device 200 on 832×480 resolution video sequences may provide approximately 5% BD-rate gains in VVC using a model having very low complexity according to some embodiments, but embodiments are not limited thereto.

Furthermore, in-loop filters according to some approaches may detect the targeted type of artifacts based on technologies designed using principles of image and signal processing. Thus, the these in-loop filters may be inflexible, and may therefore be unsuitable for detecting multiple different kinds of artifacts. However, the use of AI-based in-loop filters according to the present disclosure for quality enhancement in the video compression pipeline may facilitate detecting a wide variety of data variations (e.g., artifacts).

The plurality of modules 208 may be implemented by any suitable hardware and/or set of instructions. Further, the sequential flow illustrated in FIG. 2 is exemplary, and embodiments may include the addition/omission of operations or steps as desired. In some embodiments, the one or more operations described as being performed by the plurality of modules 208 may be performed by the at least one processor.

According to an embodiment of the present disclosure, a method for removing one or more artifacts from a video is provided. The method may include receiving, from one or more codec blocks, a plurality of reconstructed frames associated with a compressed video. The plurality of reconstructed frames includes the one or more artifacts. Further, the method may include determining at least one of a priority level and an IL of each of the received plurality of reconstructed frames. Furthermore, the method may include extracting a set of patches from the received plurality of reconstructed frames based on the determined priority level and a patch extraction criteria. The method may also include configuring an AI-based in-loop filter based on the extracted set of patches and the compressed video for removing the one or more artifacts from the compressed video.

According to an embodiment of the present disclosure, an electronic device for removing one or more artifacts from a video is disclosed. The electronic device includes at least one processor configured to receive, from one or more codec blocks, a plurality of reconstructed frames associated with a compressed video. The plurality of reconstructed frames includes the one or more artifacts. The at least one processor is also configured to determine a priority level of each of the received plurality of reconstructed frames. Further, the at least one processor are configured to extract a set of patches from the received plurality of reconstructed frames based on the determined priority level and a patch extraction criteria. The at least one processor are also configured to provide an AI-based in-loop filter based on the extracted set of patches and the compressed video for removing the one or more artifacts from the compressed video.

In an embodiment of the disclosure, a method (e.g., the process 1100) for removing one or more artifacts from a video is provided. The method (e.g., the process 1100) includes receiving (e.g., operation 1102), from one or more codec blocks, a plurality of reconstructed frames associated with a compressed video. The plurality of reconstructed frames includes the one or more artifacts. Further, the method (e.g., the process 1100) includes determining (e.g., operation 1104) a priority level of each of the received plurality of reconstructed frames. Furthermore, the method (e.g., the process 1100) includes extracting (e.g., operation 1106) a set of patches from the received plurality of reconstructed frames based on the determined priority level and a patch extraction criteria. The method (e.g., the process 1100) also includes configuring (e.g., operation 1108) an AI-based in-loop filter based on the extracted set of patches and the compressed video for removing the one or more artifacts from the compressed video.

In an embodiment of the disclosure, the method (e.g., the process 1100) may include receiving one or more characteristics associated with the AI-based in-loop filter from a user, wherein the one or more characteristics of the AI-based in-loop filter comprise a size, complexity, and an application of the AI-based in-loop filter. The method (e.g., the process 1100) may include generating the patch extraction criteria for extracting the set of patches based on the received one or more characteristics.

In an embodiment of the disclosure, the method (e.g., the process 1100) may include determining a priority of each of the extracted set of patches based on the determined priority level and the patch extraction criteria. The method (e.g., the process 1100) may include configuring the AI-based in-loop filter based on the extracted set of patches, the compressed video, and the determined priority of each of the extracted set of patches.

In an embodiment of the disclosure, the method (e.g., the process 1100) may include determining a first set of BD-BR gains associated with the plurality of reconstructed frames by using a video codec encoder and turning off one or more in-loop filters. The method (e.g., the process 1100) may include determining a second set of BD-BR gains associated with the plurality of reconstructed frames by using the video codec encoder and the one or more in-loop filters. The method (e.g., the process 1100) may include calculating a difference between each of the determined first set of BD-BR gains and each of the determined second set of BD-BR gains. The method (e.g., the process 1100) may include determining the priority level of each of the plurality of reconstructed frames based on the calculated difference.

In an embodiment of the disclosure, the method (e.g., the process 1100) may include obtaining a temporal ID for each of the plurality of reconstructed frames, wherein the temporal ID corresponds to a sequence in which a respective reconstructed frame is encoded by the video codec encoder. The method (e.g., the process 1100) may include determining the priority level of each of the plurality of reconstructed frames based on the obtained temporal ID.

In an embodiment of the disclosure, the method (e.g., the process 1100) may include extracting a plurality of patches of fixed sizes from each of the plurality of reconstructed frames. The method (e.g., the process 1100) may include generating a loss value corresponding to each of the plurality of patches based on the priority level of each of the plurality of reconstructed frames and one or more patches extracted from an original video by using a weighted loss-function, wherein the weighted loss-function penalizes one or more patches more in comparison to one or more other patches of the plurality of patches, and wherein the one or more patches are patches from the plurality of patches which are extracted from high priority level frames of the plurality of reconstructed frames. The method (e.g., the process 1100) may include training the AI-based in-loop filter based on the generated loss value.

In an embodiment of the disclosure, the method (e.g., the process 1100) may include identifying the one or more artifacts in the plurality of reconstructed frames of the compressed video by using the AI-based in-loop filter upon configuring the AI-based in-loop filter. The method (e.g., the process 1100) may include removing the identified one or more artifacts from the plurality of reconstructed frames by using the AI-based in-loop filter.

In an embodiment of the disclosure, the method (e.g., the process 1100) may include extracting a first set of patches from a first set of reconstructed frames amongst the plurality of reconstructed frames, wherein the each of the first set of reconstructed frames is having a first priority level. The method (e.g., the process 1100) may include extracting a second set of patches from a second set of reconstructed frames amongst the plurality of reconstructed frames, wherein the each of the second set of reconstructed frames is having a second priority level, wherein the first priority level is more as compared to the second priority level, and wherein a number of the first set of reconstructed frames is more than a number of the second set of reconstructed frames.

In an embodiment of the disclosure, an electronic device for removing one or more artifacts from a video is provided. The electronic device may include a receiving module (e.g., the receiving module 302) configured to receive, from one or more codec blocks, a plurality of reconstructed frames associated with a compressed video, wherein the plurality of reconstructed frames includes the one or more artifacts. The electronic device may include a determining module (e.g., the determining module 304) configured to determine a priority level of each of the received plurality of reconstructed frames. The electronic device may include an extracting module (e.g., the extracting module 306) configured to extract a set of patches from the received plurality of reconstructed frames based on the determined priority level and a patch extraction criteria. The electronic device may include a configuring module (e.g., the configuring module 308) configured to provide an AI-based in-loop filter based on the extracted set of patches and the compressed video for removing the one or more artifacts from the compressed video.

In an embodiment of the disclosure, the electronic device may be configured to receive one or more characteristics associated with the AI-based in-loop filter from a user, wherein the one or more characteristics of the AI-based in-loop filter may include a size, complexity, and an application of the AI-based in-loop filter. The electronic device may be configured to generate the patch extraction criteria for extracting the set of patches based on the received one or more characteristics.

In an embodiment of the disclosure, the electronic device may be configured to determine a priority of each of the extracted set of patches based on the determined priority level and the patch extraction criteria. The electronic device may be configured to provide the AI-based in-loop filter based on the extracted set of patches, the compressed video, and the determined priority of each of the extracted set of patches.

In an embodiment of the disclosure, the electronic device may be configured to determine a first set of BD-BR gains associated with the plurality of reconstructed frames by using a video codec encoder and turning off one or more in-loop filters. The electronic device may be configured to determine a second set of BD-BR gains associated with the plurality of reconstructed frames by using the video codec encoder and the one or more in-loop filters. The electronic device may be configured to calculate a difference between each of the determined first set of BD-BR gains and each of the determined second set of BD-BR gains. The electronic device may be configured to determine the priority level of each of the plurality of reconstructed frames based on the calculated difference.

In an embodiment of the disclosure, the electronic device may be configured to obtain a temporal ID for each of the plurality of reconstructed frames, wherein the temporal ID corresponds to a sequence in which a respective reconstructed frame is encoded by the video codec encoder. The electronic device may be configured to determine the priority level of each of the plurality of reconstructed frames based on the obtained temporal ID.

In an embodiment of the disclosure, the electronic device may be configured to extract a plurality of patches of fixed sizes from each of the plurality of reconstructed frames. In an embodiment of the disclosure, the electronic device may be configured to generate a loss value corresponding to each of the plurality of patches based on the priority level of each of the plurality of reconstructed frames and one or more patches extracted from an original video by using a weighted loss-function, wherein the weighted loss-function penalizes one or more patches more in comparison to one or more other patches of the plurality of patches, and wherein the one or more patches are patches from the plurality of patches which are extracted from high priority level frames of the plurality of reconstructed frames. The electronic device may be configured to train the AI-based in-loop filter based on the generated loss value.

In an embodiment of the disclosure, the electronic device may be configured to identify the one or more artifacts in the plurality of reconstructed frames of the compressed video by using the AI-based in-loop filter upon configuring the AI-based in-loop filter. The electronic device may be configured to remove the identified one or more artifacts from the plurality of reconstructed frames by using the AI-based in-loop filter.

In an embodiment of the disclosure, the electronic device may be configured to extract a first set of patches from a first set of reconstructed frames amongst the plurality of reconstructed frames, wherein the each of the first set of reconstructed frames is having a first priority level. The electronic device may be configured to extract a second set of patches from a second set of reconstructed frames amongst the plurality of reconstructed frames, wherein the each of the second set of reconstructed frames is having a second priority level, wherein the first priority level is more as compared to the second priority level, and wherein a number of the first set of reconstructed frames is more than a number of the second set of reconstructed frames.

In an embodiment of the disclosure, a method of processing a video is provided. The method (e.g., the process 1100) may include obtaining a plurality of reconstructed frames associated with a compressed video. The method (e.g., the process 1100) may include determining (e.g., operation 1104) a priority level of each of the plurality of reconstructed frames. The method e.g., the process (1100) may include extracting (e.g., operation 1106) a set of patches from the plurality of reconstructed frames. The method (e.g., the process 1100) may include obtaining (e.g., operation 1108) an AI-based in-loop filter trained based on at least one of the extracted set of patches and the determined priority level.

In an embodiment of the disclosure, the method (e.g., the process 1100) may include receiving one or more characteristics associated with the AI-based in-loop filter, wherein the one or more characteristics of the AI-based in-loop filter include at least one of a size, complexity, and an application of the AI-based in-loop filter. The method (e.g., the process 1100) may include generating the patch extraction criteria for extracting the set of patches based on the received one or more characteristics.

In an embodiment of the disclosure, the method (e.g., the process 1100) may include determining a priority of each of the extracted set of patches based on the determined priority level. The method (e.g., the process 1100) may include obtaining the AI-based in-loop filter based on the extracted set of patches, the compressed video, and the determined priority of each of the extracted set of patches.

In an embodiment of the disclosure, the method (e.g., the process 1100) may include determining a first parameter set including first parameters associated with the plurality of reconstructed frames without using one or more in-loop filters. The method (e.g., the process 1100) may include determining a second parameter set including second parameters associated with the plurality of reconstructed frames with using the one or more in-loop filters. The method (e.g., the process 1100) may include calculating differences between each parameter of the determined first parameter set and each parameter of the determined second parameter set. The method (e.g., the process 1100) may include determining the priority level of each of the plurality of reconstructed frames based on the calculated differences.

In an embodiment of the disclosure, the method (e.g., the process 1100) may include obtaining a temporal ID for each of the plurality of reconstructed frames, wherein the temporal ID corresponds to a sequence including each of the plurality of reconstructed frame. The method (e.g., the process 1100) may include determining the priority level of each of the plurality of reconstructed frames based on the obtained temporal ID.

In an embodiment of the disclosure, the method (e.g., the process 1100) may include generating a loss value obtained by using a weighted loss-function, wherein the weighted loss-function is modulated to be influenced more by one or more patches extracted from high priority level frames of the plurality of reconstructed frames than one or more patches extracted from low priority level frames of the plurality of reconstructed frames. The method (e.g., the process 1100) may include obtaining the AI-based in-loop filter trained based on the generated loss value.

In an embodiment of the disclosure, the method (e.g., the process 1100) may include filtering the plurality of reconstructed frames of the compressed video by using the AI-based in-loop filter.

In an embodiment of the disclosure, the method (e.g., the process 1100) may include extracting a first set of patches from a first set of reconstructed frames amongst the plurality of reconstructed frames, wherein the each of the first set of reconstructed frames is having a first priority level. The method (e.g., the process 1100) may include extracting a second set of patches from a second set of reconstructed frames amongst the plurality of reconstructed frames, wherein the each of the second set of reconstructed frames is having a second priority level, wherein a number of patches included in the first set is more than a number of patches included in the second set.

In an embodiment of the disclosure, an electronic device for processing a video, the electronic device (e.g., the electronic device 200) may include a memory storing at least one instruction, and at least one processor configured to execute the at least one instructions. The at least one processor may be configured to obtain a plurality of reconstructed frames associated with a compressed video. The at least one processor may be configured to determine a priority level of each of the plurality of reconstructed frames. The at least one processor may be configured to extract a set of patches from the plurality of reconstructed frames. The at least one processor may be configured to obtain an AI-based in-loop filter trained based on the extracted set of patches or the determined priority level.

In an embodiment of the disclosure, the at least one processor may be configured to receive one or more characteristics associated with the AI-based in-loop filter, wherein the one or more characteristics of the AI-based in-loop filter include at least one of a size, complexity, and an application of the AI-based in-loop filter. The at least one processor may be configured to generate the patch extraction criteria for extracting the set of patches based on the received one or more characteristics.

In an embodiment of the disclosure, the at least one processor may be configured to determine a priority of each of the extracted set of patches based on the determined priority level. The at least one processor may be configured to obtain the AI-based in-loop filter based on the extracted set of patches, the compressed video, and the determined priority of each of the extracted set of patches.

In an embodiment of the disclosure, the at least one processor may be configured to determine a first parameter set including first parameters associated with the plurality of reconstructed frames without one or more in-loop filters. The at least one processor may be configured to determine a second parameter set including second parameters associated with the plurality of reconstructed frames with using the one or more in-loop filters. The at least one processor may be configured to calculate differences between each parameter of the determined first parameter set and each parameter of the determined second parameter set. The at least one processor may be configured to determine the priority level of each of the plurality of reconstructed frames based on the calculated difference.

In an embodiment of the disclosure, the at least one processor may be configured to obtain a temporal ID for each of the plurality of reconstructed frames, wherein the temporal ID corresponds to a sequence including each of the plurality of reconstructed frame. The at least one processor may be configured to determine the priority level of each of the plurality of reconstructed frames based on the obtained temporal ID.

In an embodiment of the disclosure, the at least one processor may be configured to generate a loss value obtained by using a weighted loss-function, wherein the weighted loss-function is modulated to be influenced more by one or more patches extracted from high priority level frames of the plurality of reconstructed frames than one or more patches extracted from low priority level frames of the plurality of reconstructed frames. The at least one processor may be configured to obtain the AI-based in-loop filter trained based on the generated loss value.

In an embodiment of the disclosure, a computer readable medium having instructions stored therein, which when executed by at least one processor cause the at least one processor to execute a method of processing a video. The method (e.g., the process 1100) may include obtaining a plurality of reconstructed frames associated with a compressed video. The method (e.g., the process 1100) may include determining (e.g., operation 1104) a priority level of each of the plurality of reconstructed frames. The method (e.g., the process 1100) may include extracting (e.g., operation 1106) a set of patches from the plurality of reconstructed frames. The method (e.g., the process 1100) may include obtaining (e.g., operation 1108) an AI-based in-loop filter trained based on the extracted set of patches or the determined priority level.

While specific language has been used to describe the present subject matter, any limitations arising on account thereto, are not intended. As will be apparent to a person of ordinary skill in the art, various modifications which may be made in order to implement the embodiments described above without departing from the scope of the disclosure. The drawings and the foregoing description give examples of embodiments. Those of ordinary skill in the art will appreciate that one or more of the described elements may be combined into a single functional element, that one or more elements may be split into multiple functional elements, and that from one embodiment may be added to an embodiment.

What is claimed is:

1. A method of processing a video, the method comprising:
obtaining a plurality of reconstructed frames associated with a compressed video;
determining a priority level of each reconstructed frame from among the plurality of reconstructed frames;
extracting a set of patches from the plurality of reconstructed frames; and
obtaining an artificial intelligence (AI)-based in-loop filter trained based on at least one of the set of patches and the priority level.

2. The method of claim 1, further comprising:
receiving one or more characteristics associated with the AI-based in-loop filter, wherein the one or more characteristics comprise at least one of a size, a complexity, and an application corresponding to the AI-based in-loop filter; and
generating a patch extraction criteria for extracting the set of patches based on the one or more characteristics.

3. The method of claim 1, wherein the obtaining of the AI-based in-loop filter comprises:
determining a priority of each patch from among the set of patches based on the priority level; and
obtaining the AI-based in-loop filter based on the set of patches, the compressed video, and the priority of each patch.

4. The method of claim 1, wherein the determining the priority level of each reconstructed frame comprises:
determining a first parameter set comprising first parameters associated with the plurality of reconstructed frames without using one or more in-loop filters;
determining a second parameter set comprising second parameters associated with the plurality of reconstructed frames using the one or more in-loop filters;
calculating differences between each first parameter included in the first parameter set and each second parameter included in the second parameter set; and
determining the priority level of each reconstructed frame based on the differences.

5. The method of claim 1, wherein the determining of the priority level of each reconstructed frame comprises:
obtaining a temporal identifier (ID) for each reconstructed, wherein the temporal ID corresponds to a sequence comprising each reconstructed frame; and
determining the priority level each reconstructed frame based on the temporal ID.

6. The method of claim 1, wherein the plurality of reconstructed frames comprise high priority level frames and low priority level frames, wherein the high priority level frames have a higher priority level than the low priority level frames, and
wherein the obtaining of the AI-based in-loop filter comprises:
generating a loss value using a weighted loss-function, wherein the weighted loss-function is modulated to be influenced more by one or more patches extracted from the high priority level frames than one or more patches extracted from the low priority level frames; and
training the AI-based in-loop filter based on the loss value.

7. The method of claim 1, further comprising:
filtering the plurality of reconstructed frames using the AI-based in-loop filter.

8. The method of any claim 1, wherein the extracting the set of patches comprises:
extracting a first set of patches from a first set of reconstructed frames from among the plurality of reconstructed frames, wherein each frame included in the first set of reconstructed frames has a first priority level; and
extracting a second set of patches from a second set of reconstructed frames from among the plurality of reconstructed frames, wherein each frame included in the second set of reconstructed frames has a second priority level, and
wherein a number of patches included in the first set of reconstructed frames is greater than a number of patches included in the second set of reconstructed frames.

9. An electronic device for processing a video, the electronic device comprising:
at least one processor; and
a memory configured to store at least one instruction which, when executed by the at least one processor, causes the electronic device to:
obtain a plurality of reconstructed frames associated with a compressed video;
determine a priority level of each reconstructed frame from among the plurality of reconstructed frames;
extract a set of patches from the plurality of reconstructed frames; and
obtain an artificial intelligence (AI)-based in-loop filter that is trained based on at least one of the set of patches and the priority level.

10. The electronic device of claim 9, wherein the at least one instruction, when executed by the at least one processor, further causes the electronic device to:
receive one or more characteristics associated with the AI-based in-loop filter, wherein the one or more characteristics comprise at least one of a size, complexity, and an application corresponding to the AI-based in-loop filter; and
generate a patch extraction criteria for extracting the set of patches based on the one or more characteristics.

11. The electronic device of claim 9, wherein the at least one instruction, when executed by the at least one processor, further causes the electronic device to:
determine a priority of each patch from among the set of patches based on the priority level; and
obtain the AI-based in-loop filter based on the set of patches, the compressed video, and the priority of each patch.

12. The electronic device of claim 9, wherein the at least one instruction, when executed by the at least one processor, further causes the electronic device to:
determine a first parameter set comprising first parameters associated with the plurality of reconstructed frames without one or more in-loop filters;
determine a second parameter set comprising second parameters associated with the plurality of reconstructed frames using the one or more in-loop filters;
calculate differences between each first parameter included in the first parameter set and each second parameter included in the second parameter set; and
determine the priority level of each reconstructed frame based on the differences.

13. The electronic device of any claim 9, wherein the at least one instruction, when executed by the at least one processor, further causes the electronic device to:
obtain a temporal identifier (ID) for each of the plurality of reconstructed frames, wherein the temporal ID corresponds to a sequence including each reconstructed frame; and
determine the priority level of each reconstructed frame based on the temporal ID.

14. The electronic device of claim 9, wherein the plurality of reconstructed frames comprise high priority level frames and low priority level frames, wherein the high priority level frames have a higher priority level than the low priority level frames, and
wherein the at least one instruction, when executed by the at least one processor, further causes the electronic device to:
generate a loss value using a weighted loss-function, wherein the weighted loss-function is modulated to be influenced more by one or more patches extracted from the high priority level frames than one or more patches extracted from the low priority level frames; and
train the AI-based in-loop filter based on the loss value.

15. A non-transitory computer readable medium storing which, when executed by at least one processor of a device for processing a video, cause the device to:
obtain a plurality of reconstructed frames associated with a compressed video;
determine a priority level of each reconstructed frame from among the plurality of reconstructed frames;
extract a set of patches from the plurality of reconstructed frames; and
obtain an artificial intelligence (AI)-based in-loop filter trained based on at least one of the set of patches and the priority level.
